(19) United States
(12) Patent Application Publication
(10) Pub. No.: US 2025/0252790 A1
(43) Pub. Date: Aug. 7, 2025

(54) DATA MANAGEMENT DEVICE FOR VEHICLE, VEHICLE, ANALYSIS SYSTEM, STORAGE MEDIUM, AND DATA MANAGEMENT METHOD FOR VEHICLE

(71) Applicant: TOYOTA JIDOSHA KABUSHIKI KAISHA, Toyota-shi (JP)

(72) Inventor: Yohei OHATA, Suzuka-shi (JP)

(73) Assignee: TOYOTA JIDOSHA KABUSHIKI KAISHA, Toyota-shi (JP)

(21) Appl. No.: 19/017,954

(22) Filed: Jan. 13, 2025

(30) Foreign Application Priority Data
Feb. 5, 2024 (JP) 2024-015624

(51) Int. Cl. G07C 5/08

(52) U.S. Cl. CPC G07C 5/085; G07C 5/0808

(57) ABSTRACT

A data management device for a vehicle, a vehicle, an analysis system, a storage medium, and a data management method for a vehicle are provided. Processing circuitry acquires a malfunction analysis data sets for analyzing a malfunction in the vehicle when the malfunction has been detected. Newly acquired ones of the malfunction analysis data sets are stored in a first storage area until the total amount of the stored malfunction analysis data sets reaches a prescribed amount. When the newly acquired ones of the malfunction analysis data sets meet a predetermined specific condition, the newly acquired ones of the malfunction analysis data sets are stored in a second storage area using a ring buffer method.

### CROSS-REFERENCE TO RELATED APPLICATIONS

This application is based upon and claims the benefit of priority from Japanese Patent Application No. 2024-015624, filed on Feb. 5, 2024, the entire contents of which are incorporated herein by reference.

### BACKGROUND

### 1. Field

The present disclosure relates to a data management device for a vehicle, a vehicle, an analysis system, a storage medium, and a data management method for a vehicle.

### 2. Description of Related Art

The analysis system disclosed in Japanese Laid-Open Patent Publication No. 2008-234375 includes a vehicle and a terminal device. The vehicle includes a vehicle controller and various sensors. The vehicle controller includes a vehicle processing device and a storage device. The vehicle processing device determines whether there is a malfunction in a sensor or the like based on output signals from various sensors.

When having determined that there is a malfunction in a sensor or the like, the vehicle processing device stores a malfunction analysis data set for analyzing the malfunction in two storage areas of the storage device. For example, an operator at an auto repair shop operates a terminal device connected to the vehicle controller. By operating the terminal device, the operator can read or delete the malfunction analysis data sets stored in the two storage areas.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a first general aspect, a data management device for a vehicle includes processing circuitry configured to perform: acquiring malfunction analysis data sets for analyzing a malfunction in the vehicle when the malfunction has been detected; storing newly acquired ones of the malfunction analysis data sets in a first storage area until a total amount of the stored malfunction analysis data sets reaches a prescribed amount; and when the newly acquired ones of the malfunction analysis data sets meet a predetermined specific condition, storing the newly acquired ones of the malfunction analysis data sets in a second storage area using a ring buffer method.

In a second general aspect, a vehicle includes the data management device according to the first general aspect and a storage device that stores the malfunction analysis data sets for analyzing a malfunction in the vehicle. The storage device includes the first storage area and the second storage area. The data management device includes the processing circuitry. The processing circuitry is configured to perform: acquiring the malfunction analysis data sets when a malfunction in the vehicle has been detected; storing newly acquired ones of the malfunction analysis data sets in the first storage area until a total amount of the stored malfunction analysis data sets reaches a prescribed amount; and when the newly acquired ones of the malfunction analysis data sets meet a predetermined specific condition, storing the newly acquired ones of the malfunction analysis data sets in the second storage area using a ring buffer method.

In a third general aspect, an analysis system includes the data management device according to the first general aspect mounted on a vehicle, a storage device mounted on the vehicle, and a terminal device located outside the vehicle. The storage device stores the malfunction analysis data sets for analyzing a malfunction in the vehicle. The terminal device is capable of communicating with the data management device. The storage device includes the first storage area and the second storage area. The data management device includes the processing circuitry. The processing circuitry is configured to perform: acquiring the malfunction analysis data sets when a malfunction in the vehicle has been detected; storing newly acquired ones of the malfunction analysis data sets in the first storage area until a total amount of the stored malfunction analysis data sets reaches a prescribed amount; when the newly acquired ones of the malfunction analysis data sets meet a predetermined specific condition, storing the newly acquired ones of the malfunction analysis data sets in the second storage area using a ring buffer method; and transmitting the malfunction analysis data sets stored in the first storage area to the terminal device in response to an acquisition request signal from the terminal device.

In a fourth general aspect, a non-transitory computer-readable storage medium stores a data management program for causing processing circuitry to execute a data management process for a vehicle. The processing circuitry is mounted on the vehicle. The data management process includes: acquiring malfunction analysis data sets for analyzing a malfunction in the vehicle when the malfunction has been detected; storing newly acquired ones of the malfunction analysis data sets in a first storage area until a total amount of the stored malfunction analysis data sets reaches a prescribed amount; and when the newly acquired ones of the malfunction analysis data sets meet a predetermined specific condition, storing the newly acquired ones of the malfunction analysis data sets in a second storage area using a ring buffer method.

In a fifth general aspect, a data management method for a vehicle is executed by processing circuitry mounted on the vehicle. The method includes: acquiring malfunction analysis data sets for analyzing a malfunction in the vehicle when the malfunction has been detected; storing newly acquired ones of the malfunction analysis data sets in a first storage area until a total amount of the stored malfunction analysis data sets reaches a prescribed amount; and when the newly acquired ones of the malfunction analysis data sets meet a predetermined specific condition, storing the newly acquired ones of the malfunction analysis data sets in a second storage area using a ring buffer method.

According to the above-described configuration or method, when a newly acquired malfunction analysis data set meets the specific condition, the malfunction analysis data set is stored not only in the first storage area but also in the second storage area. For example, only an important malfunction analysis data set is stored in the first storage area and the second storage area. Thus, for example, an important malfunction analysis data set is stored in both the first storage area and the second storage area. On the other hand, the storage frequency at which a malfunction analysis data set is stored in the second storage area can be made lower than the storage frequency of the first storage area. Furthermore, the second storage area operates on a ring buffer method. Thus, even when the capacity of the second storage area is full, the oldest data set in the second storage area is overwritten, allowing the newly acquired malfunction analysis data set to be stored in the second storage area. In other words, this configuration prevents a situation in which a new malfunction analysis data set cannot be stored in the second storage area.

For example, the vehicle controller of the above-described document stores a malfunction analysis data set in two storage areas in the storage device each time it is determined that there is a malfunction. Consequently, as the number of malfunction detections increases, the available capacity in the storage areas within the storage device decreases. Ultimately, if the storage capacity becomes fully utilized, new malfunction analysis data sets cannot be stored in the storage areas. The above-described configuration and method reduce/eliminate the occurrences of this issue.

Other features and aspects will be apparent from the following detailed description, the drawings, and the claims.

### BRIEF DESCRIPTION OF THE DRAWINGS

FIG. 1 is a schematic diagram illustrating an analysis system.

FIG. 2 is a functional block diagram of the controller shown in FIG. 1.

FIG. 3 is a flowchart showing a storage control executed by the controller in FIG. 2.

FIG. 4 is a sequence diagram showing a data acquisition control executed by the controller in FIG. 2.

FIG. 5 is a sequence diagram showing a storage deletion control executed by the controller in FIG. 2.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### Schematic Configuration of Analysis System

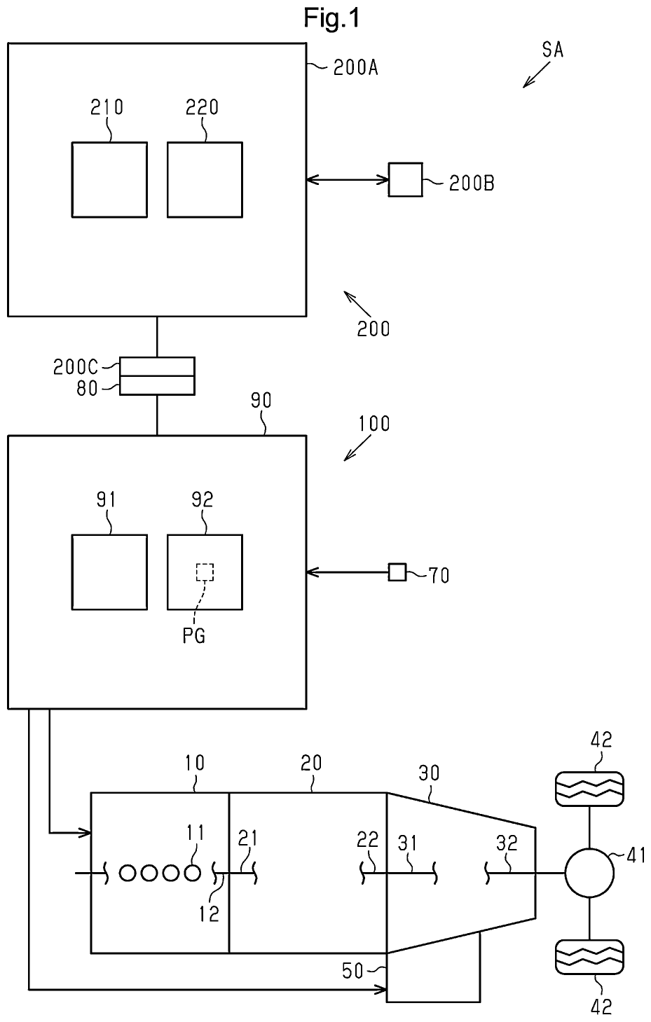

FIGS. 1 to 5 illustrate a vehicle data management device, a vehicle, an analysis system, a storage medium, a data management process, a data management program, a data management program product, and a vehicle data management method according to an embodiment of the present disclosure. First, a schematic configuration of an analysis system SA will be described.

As shown in FIG. 1, the analysis system SA includes a vehicle 100. The vehicle 100 is owned by a user, for example. The vehicle 100 includes an internal combustion engine 10, a torque converter 20, an automatic transmission 30, a differential 41, drive wheels 42, and a hydraulic mechanism 50.

The internal combustion engine 10 includes four cylinders 11 and a crankshaft 12. The cylinders 11 provide spaces for the combustion of a mixture of fuel and intake air. The combustion of the mixture in the cylinders 11 causes the crankshaft 12 to rotate.

The torque converter 20 includes an input shaft 21 and an output shaft 22. The torque converter 20 transmits the driving force of the input shaft 21 to the output shaft 22 via a fluid. The torque converter 20 decelerates the rotation of the input shaft 21 and outputs the decelerated rotation from the output shaft 22. A first end of the input shaft 21 is connected to the crankshaft 12. The torque converter 20 includes a lock-up clutch (not shown). A second end of the input shaft 21 is connected to a first end of the output shaft 22 via the lock-up clutch. Accordingly, the input shaft 21 and the output shaft 22 rotate integrally rotate when the lock-up clutch is engaged.

The automatic transmission 30 includes an input shaft 31 and an output shaft 32. A first end of the input shaft 31 is connected to a second end of the output shaft 22 of the torque converter 20. A second end of the input shaft 31 is connected to a first end of the output shaft 32 via a clutch and gears (not shown). A second end of the output shaft 32 is connected to the left and right drive wheels 42 via the differential 41. The automatic transmission 30 is capable of changing the gear ratio, which is the ratio of the rotation speed of the input shaft 31 to the rotation speed of the output shaft 32. The gear ratio of the automatic transmission 30 indicates the number of rotations the input shaft 31 makes when the output shaft 32 completes one rotation. Therefore, the higher the gear ratio, the faster the input shaft 31 rotates relative to the output shaft 32. The automatic transmission 30 may be of a multi-speed type. Therefore, the automatic transmission 30 changes the gear ratio by changing the gear stage.

The hydraulic mechanism 50 is attached to the automatic transmission 30. The hydraulic mechanism 50 supplies oil to the automatic transmission 30. The operation of the automatic transmission 30 is controlled by the oil supplied from the hydraulic mechanism 50.

As shown in FIG. 1, the vehicle 100 includes various sensors 70. Examples of the various sensors 70 include multiple sensors such as an accelerator operation amount sensor, a vehicle speed sensor, and an acceleration sensor. FIG. 1 shows only one of the sensors 70.

As shown in FIG. 1, the vehicle 100 includes a vehicle controller 90. The vehicle controller 90 includes a vehicle processing device 91 and a vehicle storage device 92. An example of the vehicle processing device 91 is a CPU. The vehicle storage device 92 includes a ROM, which only allows data to be read, a RAM, which is a volatile memory allowing data to be read and written, and a non-volatile storage allowing data to be read and written. The vehicle storage device 92 stores various programs and various data sets in advance. Specifically, the vehicle storage device 92 stores a control program PG in advance as one of various programs. The vehicle processing device 91 is processing circuitry that executes various processes described later by executing the control program PG stored in the vehicle storage device 92. The vehicle processing device 91 executes the control program PG stored in the vehicle storage device 92, thereby implementing a function as a data management device 91Z described later. That is, the vehicle processing device 91 and the data management device 91Z are installed in the vehicle 100. In other words, the vehicle processing device 91 executes various processes related to the data management method and the data management process. In the present embodiment, the control program PG is an example of the data management program.

The vehicle controller 90 acquires various pieces of information from the various sensors 70. The vehicle processing device 91 of the vehicle controller 90 controls the internal combustion engine 10 and the automatic transmission 30 based on the information acquired from the various sensors 70. Specifically, the vehicle processing device 91 controls the internal combustion engine 10 by outputting control signals to the internal combustion engine 10. The vehicle processing device 91 controls the automatic transmission 30 via the hydraulic mechanism 50 by outputting control signals to the hydraulic mechanism 50.

The vehicle 100 includes a vehicle connector 80. The vehicle connector 80 is connected to the vehicle controller 90. When the vehicle controller 90 is connected to another device via the vehicle connector 80, the vehicle controller 90 can communicate with the other device via the vehicle connector 80.

As shown in FIG. 1, the analysis system SA includes a terminal device 200. The terminal device 200 is installed in a place where maintenance or the like of the vehicle 100 is performed, for example, an auto repair shop or the like. In other words, the terminal device 200 is a device located outside the vehicle 100.

The terminal device 200 includes a terminal body 200A, a terminal display 200B, and a terminal connector 200C. The terminal display 200B is configured to display various images. The terminal display 200B is a touch screen. This allows an operator or other user in an auto repair shop to input various kinds of information via the terminal display 200B. The terminal display 200B is connected to the terminal body 200A. The terminal connector 200C is connected to the terminal body 200A. When the terminal body 200A is connected to another device via the terminal connector 200C, the terminal body 200A can communicate with the other device via the terminal connector 200C.

The terminal body 200A includes a terminal processing device 210 and a terminal storage device 220. An example of the terminal processing device 210 is a CPU. The terminal storage device 220 includes a ROM, which only allows data to be read, a RAM, which is a volatile memory allowing data to be read and written, and a non-volatile storage allowing data to be read and written. The terminal storage device 220 stores various programs and various data sets in advance. The terminal processing device 210 is processing circuitry that executes programs stored in the terminal storage device 220 to execute various processes described later.

### Peripheral Configuration of Data Management Device

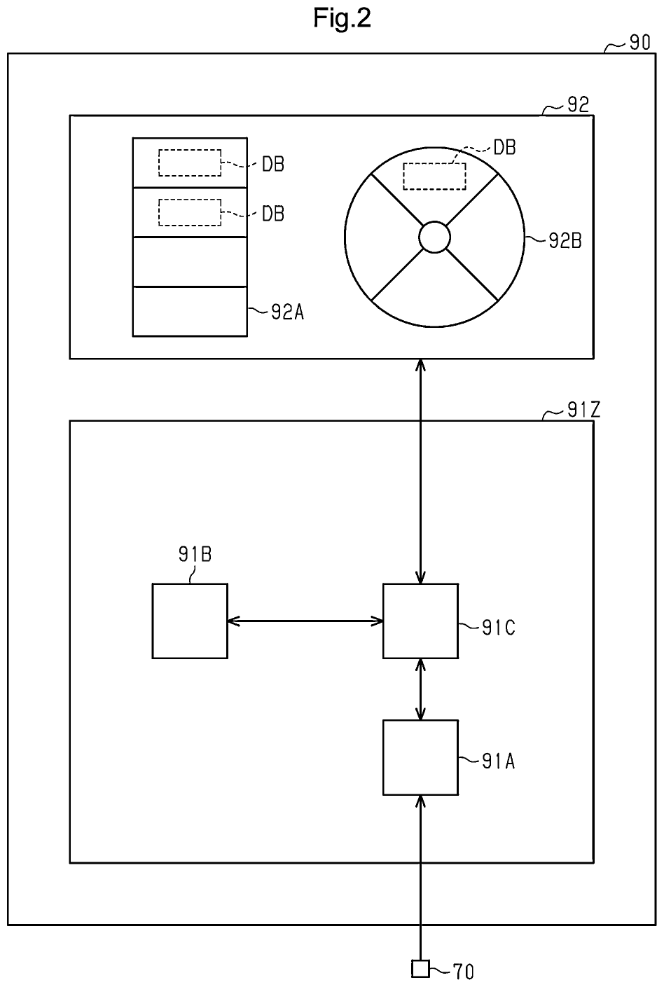

Next, the peripheral configuration of the data management device 91Z will be described with reference to FIG. 2. As shown in FIG. 2, the data management device 91Z designates one of the storage areas provided in the vehicle storage device 92 as a first storage area 92A. The data management device 91Z designates one of the storage areas of the vehicle storage device 92, separate from the first storage area 92A, as a second storage area 92B. In the present embodiment, the first storage area 92A is a non-volatile storage in the vehicle storage device 92 that allows both reading and writing. The second storage area 92B is also a non-volatile storage in the vehicle storage device 92 that allows both reading and writing.

The first storage area 92A stores malfunction analysis data sets DB in a storage control described later. The malfunction analysis data sets DB are used to analyze malfunctions of the vehicle 100. Malfunctions of the vehicle 100 include, for example, a physical malfunction of the sensor 70, a communication error between the sensor 70 and the vehicle controller 90, an error on an internal program of the vehicle controller 90, and the like. The data management device 91Z store newly acquired malfunction analysis data sets DB in the first storage area 92A until the total amount of the stored malfunction analysis data sets DB reaches a prescribed amount. Specifically, the data management device 91Z stores the malfunction analysis data sets DB in the first storage area 92A in the following manner. As a precondition, the first storage area 92A has storage locations for, for example, X malfunction analysis data sets DB, where X is an integer greater than or equal to 2. Each of these X storage locations is pre-assigned a number from 1 to X. When storing malfunction analysis data sets DB in the first storage area 92A, the data management device 91Z uses the lowest available numbered storage location from 1 to X in sequential order. For example, if the last stored malfunction analysis data set DB was in storage location number 1, the data management device 91Z stores the new malfunction analysis data set DB in storage location number 2. For example, if the last stored malfunction analysis data set DB was in storage location number 2, the data management device 91Z stores the new malfunction analysis data set DB in storage location number 3. If the last malfunction analysis data set DB was stored in storage location number X, the data management device 91Z does not store the new malfunction analysis data set DB in the first storage area 92A. Thus, when there is no available space in the first storage area 92A, the data management device 91Z will not store any new malfunction analysis data set DB in the first storage area 92A. FIG. 2 illustrates, by way of example, a configuration in which the first storage area 92A has four storage locations for data sets.

The second storage area 92B stores malfunction analysis data sets DB in a storage control described later. The data management device 91Z stores newly acquired malfunction analysis data sets DB in the second storage area 92B using a ring buffer method. Specifically, the data management device 91Z stores the malfunction analysis data sets DB in the second storage area 92B in the following manner. As a precondition, the second storage area 92B has storage locations for, for example, N malfunction analysis data sets DB, where Nis an integer greater than or equal to 2. Each of these N storage locations is pre-assigned a number from 1 to N. When storing malfunction analysis data sets DB in the second storage area 92B, the data management device 91Z uses the lowest available numbered storage location from 1 to N in sequential order. For example, if the last stored malfunction analysis data set DB was in storage location number 1, the data management device 91Z stores the new malfunction analysis data set DB in storage location number 2. For example, if the last stored malfunction analysis data set DB was in storage location number 2, the data management device 91Z stores the new malfunction analysis data set DB in storage location number 3. On the other hand, if the last stored malfunction analysis data set DB was in storage location number N of the second storage area 92B, the data management device 91Z stores the new malfunction analysis data set DB in storage location number 1 of the second storage area 92B. The second storage area 92B operates on a ring buffer method. Therefore, even when the storage capacity of the second storage area 92B is full, the oldest malfunction analysis data set DB in the second storage area 92B, in this case, storage location number 1 of the second storage area 92B is rewritten. Accordingly, the new malfunction analysis data set DB is stored in the second storage area 92B. FIG. 2 illustrates, by way of example, a configuration in which the second storage area 92B has four storage locations for data sets.

The data management device 91Z includes, as functional blocks, a reception unit 91A, an internal monitoring unit 91B, and a malfunction writing unit 91C. The reception unit 91A receives information from the various sensors 70. The internal monitoring unit 91B acquires information processed by the vehicle controller 90 such as values calculated by the vehicle controller 90 and values output by the vehicle controller 90. The malfunction writing unit 91C is capable of acquiring information from the various sensors 70 via the reception unit 91A. The malfunction writing unit 91C is configured to acquire information processed by the vehicle controller 90 via the internal monitoring unit 91B. The malfunction writing unit 91C is capable of communicating with the first storage area 92A. The malfunction writing unit 91C is capable of communicating with the second storage area 92B.

### Storage Control

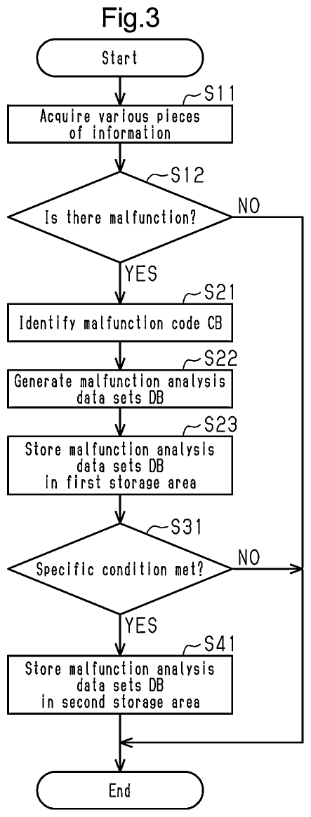

With reference to FIG. 3, a storage control executed by the data management device 91Z will be described. The storage control is a control for storing malfunction analysis data sets DB. In the present embodiment, the malfunction writing unit 91C of the data management device 91Z starts the storage control at predetermined control cycles.

As illustrated in FIG. 3, when starting the storage control, the malfunction writing unit 91C of the data management device 91Z executes the process of step S11. In step S11, the malfunction writing unit 91C acquires information from the various sensors 70 via the reception unit 91A. The malfunction writing unit 91C acquires information processed by the vehicle controller 90 via the internal monitoring unit 91B. After step S11, the malfunction writing unit 91C advances the process to step S12.

In step S12, the malfunction writing unit 91C determines whether there is a malfunction in the vehicle 100 based on the information from the various sensors 70 and the information processed by the vehicle controller 90. For example, when all of the information from the various sensors 70 and the information processed by the vehicle controller 90 are within predetermined normal ranges, the malfunction writing unit 91C determines that there is no malfunction in the vehicle 100. On the other hand, when at least one or more pieces of information among the information from the various sensors 70 and the information processed by the vehicle controller 90 are outside the predetermined normal ranges, the malfunction writing unit 91C determines that there is a malfunction in the vehicle 100. These normal ranges are arbitrarily set in advance for each parameter contained in the information, based on the configurations of various components in the vehicle 100, such as the internal combustion engine 10, or the communication standards of each communication device within the vehicle 100. When the malfunction writing unit 91C has determined that there is no malfunction in the vehicle 100 in step S12 (S12: NO), the malfunction writing unit 91C ends the current storage control. On the other hand, when the malfunction writing unit 91C has determined that there is a malfunction in the vehicle 100 in step S12 (S12: YES), the malfunction writing unit 91C advances the process to step S21. In other words, if a malfunction in the vehicle 100 has been detected, the malfunction writing unit 91C advances the process to step S21.

In step S21, the malfunction writing unit 91C identifies a malfunction code CB indicating the type of malfunction in the vehicle 100 based on the information from the various sensors 70 and the information processed by the vehicle controller 90. For example, the malfunction writing unit 91C identifies the malfunction code CB by associating the information from the various sensors 70 and the information processed by the vehicle controller 90 with a malfunction table defined in advance. The malfunction table associates a combination of the information from the various sensors 70 and the information processed by the vehicle controller 90 with the malfunction code CB. The malfunction code CB is broadly classified for each system included in the vehicle 100. Additionally, the malfunction code CB is subdivided by the contents of the malfunction for each system. Specifically, the malfunction code CB is represented alphanumerically, such as P0131. In this alphanumeric malfunction code CB, the initial part indicates the malfunctioning system among the multiple systems included in the vehicle 100. Examples of systems within the vehicle 100 include the body system, the chassis system, the powertrain system, and the network system. The latter part of the malfunction code CB details the malfunction within the indicated system. The details of the malfunction are classified into, for example, a physical malfunction of the sensor 70, a communication error between the sensors 70 and the vehicle controller 90, and an error on an internal program of the vehicle controller 90. The malfunction types described above are merely examples. Other malfunction types may exist, and the malfunction types may also be further subdivided. The malfunction code CB is sometimes referred to as a DTC, an abbreviation for Diagnostic Trouble Code. After step S21, the malfunction writing unit 91C advances the process to step S22.

In step S22, the malfunction writing unit 91C generates malfunction analysis data sets DB. In the present embodiment, each malfunction analysis data set DB is a collection of data sets including the malfunction code CB identified in step S21, the information from the various sensors 70 acquired in step S11, and the information processed by the vehicle controller 90. As described above, in the present embodiment, the malfunction writing unit 91C acquires malfunction analysis data sets DB by generating the malfunction analysis data set DB. In the present embodiment, the information processed by the vehicle controller 90, which has been acquired in step S11, includes a data set indicating the total travel distance of the vehicle 100. Therefore, the malfunction analysis data sets DB include a data set indicating the traveling state of the vehicle 100. In other words, the malfunction analysis data set DB includes a data set indicating the total travel distance of the vehicle 100 as a data set indicating the traveling state of the vehicle 100. The malfunction analysis data sets DB may be referred to as DTC snapshot record data. After step S22, the malfunction writing unit 91C advances the process to step S23.

In step S23, the malfunction writing unit 91C stores newly acquired malfunction analysis data sets DB in the first storage area 92A. Thereafter, the malfunction writing unit 91C advances the process to step S31. When the total amount of the malfunction analysis data sets DB stored in the first storage area 92A reaches a prescribed amount, the malfunction writing unit 91C does not store newly acquired malfunction analysis data sets DB in the first storage area 92A. In this case also, the malfunction writing unit 91C advances the process to step S31. In the present embodiment, the process of step S23 is a process of storing newly acquired malfunction analysis data sets DB in the first storage area 92A until the total amount of the stored malfunction analysis data sets DB reaches the prescribed amount.

In step S31, the malfunction writing unit 91C determines whether the malfunction analysis data sets DB meet a predetermined specific condition. Specifically, the malfunction writing unit 91C determines whether the malfunction code CB included in each malfunction analysis data set DB is a predetermined specific code. The specific code indicates a specific malfunction type among multiple malfunction types categorized in advance for each system included in the vehicle 100. For example, the specific malfunction type of the body system of the vehicle 100 includes a physical malfunction of the sensor 70. The specific malfunction type of the chassis system of the vehicle 100 includes a physical malfunction of the sensor 70. The specific malfunction type of the powertrain system of the vehicle 100 includes a physical malfunction of the sensor 70 and a communication error between the sensor 70 and the vehicle controller 90. The specific malfunction type of the network system of the vehicle 100 includes a physical malfunction of the sensor 70. The specific malfunction types described above are merely examples. The specific malfunction type may be different or the same between the systems included in the vehicle 100. The specific condition of the present embodiment includes a requirement that the malfunction analysis data set DB corresponds to a specific system among the systems included in the vehicle 100, and corresponds to a specific malfunction type among the multiple malfunction types categorized in advance.

In a case in which the malfunction writing unit 91C has determined that the malfunction analysis data set DB does not meet the specific condition in step S31 (S31: NO), the malfunction writing unit 91C ends the current storage control. On the other hand, in a case in which the malfunction writing unit 91C has determined that the malfunction analysis data set DB meets the specific condition in Step S31 (S31: YES), the malfunction writing unit 91C advances the process to step S41.

In step S41, the malfunction writing unit 91C stores the malfunction analysis data set DB in the second storage area 92B. Specifically, the malfunction writing unit 91C stores newly acquired malfunction analysis data sets DB in the second storage area 92B using a ring buffer method. In the present embodiment, the processes of step S31 and step S41 are processes of storing newly acquired malfunction analysis data sets DB in the second storage area 92B using a ring buffer method when the newly acquired malfunction analysis data sets DB meet the predetermined specific condition. After step S41, the malfunction writing unit 91C ends the current storage control.

### Data Acquisition Control

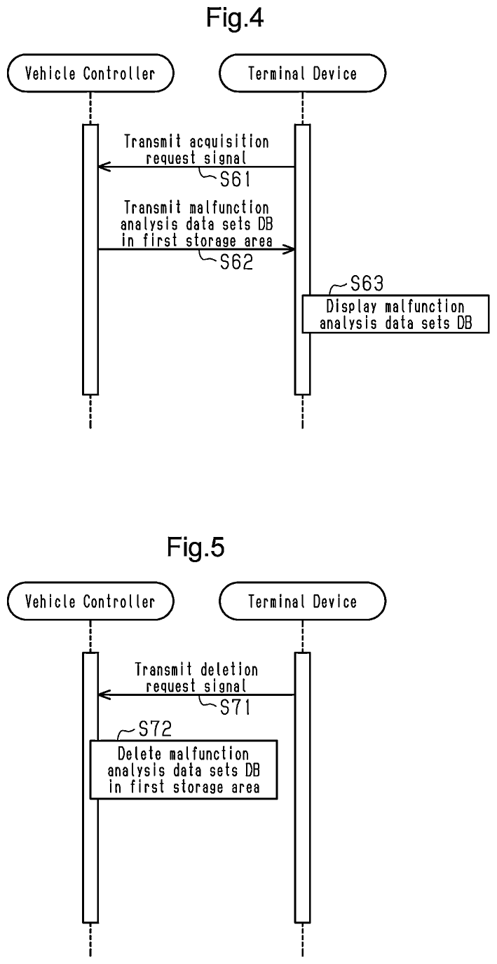

A data acquisition control executed by the vehicle controller 90 and the terminal device 200 will now be described with reference to FIG. 4. In the data acquisition control, the terminal device 200 acquires a malfunction analysis data set DB of the vehicle 100. In the present embodiment, for example, it is a necessary condition that the terminal connector 200C is connected to the vehicle connector 80. When an operator or other user requests acquisition of a malfunction analysis data set DB via the terminal display 200B, the terminal device 200 starts the data acquisition control.

As shown in FIG. 4, when starting the data acquisition control, the terminal processing device 210 executes the process of step S61. In step S61, the terminal processing device 210 transmits an acquisition request signal to the vehicle controller 90. When the vehicle controller 90 has acquired the acquisition request signal, the data management device 91Z of the vehicle controller 90 advances the process to step S62.

In step S62, the data management device 91Z of the vehicle controller 90 transmits all the malfunction analysis data sets DB stored in the first storage area 92A to the terminal device 200. When the terminal device 200 has acquired the malfunction analysis data sets DB, the terminal processing device 210 stores the malfunction analysis data sets DB in the terminal storage device 220. After step S62, the terminal processing device 210 advances the process to step S63.

In step S63, the terminal processing device 210 outputs a control signal to the terminal display 200B to display the malfunction analysis data sets DB on the terminal display 200B. In step S63, the terminal processing device 210 ends the current data acquisition control.

### Storage Deletion Control

A storage deletion control executed by the vehicle controller 90 and the terminal device 200 will now be described with reference to FIG. 5. The storage deletion control deletes the malfunction analysis data sets DB stored in the first storage area 92A of the vehicle 100. In the present embodiment, it is a necessary condition that the terminal connector 200C is connected to the vehicle connector 80. When an operator or other user requests to delete the malfunction analysis data sets DB via the terminal display 200B, the terminal device 200 starts the data deletion control.

As shown in FIG. 5, when the storage deletion control is started, the terminal processing device 210 executes the process of step S71. In step S71, the terminal processing device 210 transmits a deletion request signal to the vehicle controller 90. If the vehicle controller 90 has acquired the deletion request signal, the data management device 91Z of the vehicle controller 90 advances the process to step S72.

In step S72, the data management device 91Z of the vehicle controller 90 deletes all the malfunction analysis data sets DB stored in the first storage area 92A. On the other hand, the data management device 91Z maintains all the malfunction analysis data sets DB stored in the second storage area 92B. In other words, the malfunction analysis data set DB in the second storage area 92B cannot be deleted by signals from the terminal device 200. After step S72, the data management device 91Z ends the current storage deletion control.

### OPERATION OF PRESENT EMBODIMENT

When a malfunction occurs in the vehicle 100, the malfunction writing unit 91C of the data management device 91Z stores a malfunction analysis data set DB for analyzing the malfunction in the vehicle 100 in the first storage area 92A in step S23 of the storage control as shown in FIG. 3. When the malfunction analysis data set DB meets the predetermined specific condition, the malfunction writing unit 91C stores newly acquired malfunction analysis data set DB in the second storage area 92B using a ring buffer method in step S41.

### Advantages of the Present Embodiment

(1) According to the present embodiment, when newly acquired malfunction analysis data sets DB meet the specific condition, the malfunction analysis data sets DB are stored not only in the first storage area 92A but also in the second storage area 92B. For example, malfunction analysis data sets DB with a high level of importance are stored in the second storage area 92B. Thus, it is possible to reduce the frequency with which malfunction analysis data sets DB are stored in the second storage area 92B. Consequently, there is no need to prepare an excessively large storage capacity for the second storage area 92B. Further, the second storage area 92B operates on a ring buffer method. Therefore, when the capacity of the second storage area 92B is full, the oldest data set in the second storage area 92B is rewritten. This allows a new malfunction analysis data set DB to be stored in the second storage area 92B. It is thus possible to avoid the occurrence of a situation in which a new malfunction analysis data set DB cannot be stored in the second storage area 92B.
(2) Generally, the level of importance of a malfunction in the vehicle 100 may vary depending on the type of the malfunction. In this regard, the specific condition in step S31 includes the requirement that the malfunction analysis data set DB corresponds to a specific malfunction type among the multiple malfunction types categorized in advance. Therefore, it is possible to control whether to execute the process of storing the malfunction analysis data set DB in the second storage area 92B depending on the malfunction type of the vehicle 100, in other words, according to the importance associated with the malfunction type.
(3) Generally, the importance of a malfunction differs between systems within the vehicle 100. For example, a malfunction analysis data set DB related to a communication error in the body system of the vehicle 100 may have a relatively low necessity for storage. In contrast, a malfunction analysis data set DB related to a communication error in the powertrain system of the vehicle 100 may have a relatively high necessity for storage.

In this regard, the specific condition in step S31 includes a requirement that the malfunction analysis data set DB corresponds to a specific system among the systems included in the vehicle 100, and corresponds to a specific malfunction type among the multiple malfunction types categorized in advance. Accordingly, for instance, a malfunction analysis data set DB related to a communication error in the body system is not stored in the second storage area 92B, while a malfunction analysis data set DB for a communication error in the powertrain system may be stored in the second storage area 92B. This arrangement enables categorization based on system type. That is, it is possible to switch whether to execute the process of storing the malfunction analysis data set DB in the second storage area 92B according to the importance of the malfunction for each system.
(4) The location of a malfunction that occurs in the vehicle 100 may change depending on the traveling state of the vehicle 100. In addition, the frequency of malfunctions occurring in the vehicle 100 may vary. In this regard, the malfunction analysis data sets DB include a data set indicating the traveling state of the vehicle 100. According to this configuration, it is possible to appropriately analyze a malfunction in the vehicle 100 by referring to a data set indicating the traveling state of the vehicle 100 in the malfunction analysis data sets DB, that is, by referring to the data set having high relevance to the malfunction in the vehicle 100.
(5) Among the information indicating the traveling state of vehicle 100, the location of a malfunction occurring within the vehicle 100 is particularly likely to vary depending on changes in the total travel distance of the vehicle 100. The frequency of malfunctions that occur in the vehicle 100 also tends to change in accordance with changes in the total travel distance of the vehicle 100. In this regard, the malfunction analysis data set DB include a data set indicating the total travel distance of the vehicle 100 as a data set indicating the traveling state of the vehicle 100. According to this configuration, it is possible to appropriately analyze a malfunction in the vehicle 100 by referring to the data set indicating the total travel distance of the vehicle 100 in the malfunction analysis data sets DB, that is, by referring to the data set having high relevance to the malfunction in the vehicle 100.
(6) The first storage area 92A is a non-volatile storage area. Consequently, even if power supply to the vehicle controller 90 is interrupted, it is possible to prevent the malfunction analysis data set DB stored in the first storage area 92A from being lost.
(7) The second storage area 92B is a non-volatile storage area. Consequently, even if power supply to the vehicle controller 90 is interrupted, it is possible to prevent the malfunction analysis data set DB stored in the second storage area 92B from being lost.
(8) As shown in FIG. 4, in the data acquisition control, the data management device 91Z of the vehicle 100 transmits the malfunction analysis data sets DB stored in the first storage area 92A to the terminal device 200 in response to the acquisition request signal from the terminal device 200. This allows an operator, for example, in an auto repair shop or the like to access the malfunction analysis data sets DB via the terminal device 200.
(9) As shown in FIG. 5, in the storage deletion control, the data management device 91Z in the vehicle 100 deletes only the malfunction analysis data sets DB stored in the first storage area 92A in response to the deletion request signal from the terminal device 200. This allows an operator, for example, in an auto repair shop or the like to delete unnecessary ones of the malfunction analysis data sets DB stored in the first storage area 92A in the vehicle 100 by operating the terminal device 200. On the other hand, the operator cannot the malfunction analysis data sets DB stored in the second storage area 92B of the vehicle 100 even through manipulation of the terminal device 200. Therefore, it is possible to prevent the malfunction analysis data sets DB stored in the second storage area 92B from being unintentionally deleted, for example, due to an erroneous operation of the terminal device 200.

### Modifications

The above-described embodiment may be modified as follows. The above-described embodiment and the following modifications can be combined as long as the combined modifications remain technically consistent with each other.

In the above-described embodiment, the storage control may be changed.

For example, in step S22, the method of generating the malfunction analysis data sets DB may be changed. Specifically, the malfunction analysis data sets DB may include, as the data set indicating the traveling state of the vehicle 100, other data sets instead of or in addition to the data set indicating the total travel distance of the vehicle 100. Examples of other data sets may include a data set indicating the speed of the vehicle 100, a data set indicating the operation amount of the accelerator pedal of the vehicle 100, a data set indicating the operation amount of the brake pedal of the vehicle 100, and a data set indicating the acceleration of the vehicle 100. The malfunction analysis data sets DB do not necessarily need to include a data set indicating the traveling state of the vehicle 100.

For example, the specific condition of step S31 may be changed. Specifically, the specific condition may include another requirement in place of or in addition to the requirement that the malfunction analysis data set DB corresponds to a specific system among the systems included in the vehicle 100 and corresponds to a specific malfunction type among the multiple malfunction types categorized in advance. An example of another requirement may include a condition that the frequency of malfunctions corresponding to the malfunction analysis data sets DB is higher than or equal to a prescribed frequency. Also, the specific condition may include only the requirement that the malfunction analysis data sets DB correspond to a specific malfunction type among the multiple malfunction types categorized in advance. As an example, in a case in which the difference in the importance among the systems of the vehicle 100 is relatively small, the influence of the change is relatively small even if the specific condition is that the malfunction analysis data sets DB correspond to a specific system among the multiple systems in the vehicle 100.

The entity that executes the storage control process may be changed. Specifically, among the devices in the vehicle 100, a device other than the vehicle controller 90 can execute the processes of step S11 and step S12. In other words, a device other than the data management device 91Z may be able to execute the processes of steps S11 and S12.

In the above-described embodiment, the data acquisition control may be changed.

For example, in step S62, the data management device 91Z of the vehicle controller 90 may transmit only part of the malfunction analysis data sets DB stored in the first storage area 92A to the terminal device 200.

For example, in step S62, the data management device 91Z of the vehicle controller 90 may transmit all the malfunction analysis data sets DB stored in the second storage area 92B to the terminal device 200, in addition to or instead of all the malfunction analysis data sets DB stored in the first storage area 92A.

In the above-described embodiment, the storage deletion control may be changed.

For example, in step S72, the data management device 91Z of the vehicle controller 90 may delete part of the malfunction analysis data sets DB stored in the first storage area 92A.

For example, in step S72, the data management device 91Z of the vehicle controller 90 may delete all the malfunction analysis data sets DB stored in the second storage area 92B, in addition to or instead of all the malfunction analysis data sets DB stored in the first storage area 92A. To prevent unintentional deletion of the malfunction analysis data sets DB stored in the second storage area 92B, the malfunction analysis data sets DB stored in the second storage area 92B may be deleted in response to a deletion request signal from a device different from the terminal device 200.

In the above-described embodiment, the storage deletion control in response to the deletion request signal from the terminal device 200 may be omitted. For example, in step S62 of the data acquisition control, the data management device 91Z of the vehicle controller 90 may delete the malfunction analysis data sets DB stored in the first storage area 92A after transmitting the malfunction analysis data sets DB stored in the first storage area 92A to the terminal device 200. In this case, the impact of this modification would be minimal.

In the above-described embodiment, the configuration of the analysis system SA may be changed.

For example, the vehicle controller 90 and the terminal device 200 may be able to communicate with each other without using the vehicle connector 80 and the terminal connector 200C.

For example, the configuration of the vehicle storage device 92 may be changed. Specifically, the first storage area 92A may be a volatile storage area. Even in this case, if power supply to the vehicle controller 90 can be maintained, the loss of the malfunction analysis data set DB stored in the first storage area 92A can be prevented. The second storage area 92B may be a volatile storage area. Even in this case, if power supply to the vehicle controller 90 can be maintained, the loss of the malfunction analysis data set DB stored in the second storage area 92B can be prevented.

For example, the configuration of the vehicle controller 90 may be changed. Specifically, the vehicle controller 90 may include multiple devices. In other words, a device including the vehicle processing device 91 and a device including the vehicle storage device 92 may be different from each other. The device including the first storage area 92A and the device including the second storage area 92B may be different from each other. Further, the device functioning as the reception unit 91A, the device functioning as the internal monitoring unit 91B, and the device functioning as the malfunction writing unit 91C may be different from each other.

Any processing device may be used the vehicle processing device 91 and the terminal processing device 210 as long as the device includes a CPU and a ROM and execute software processing. The processing device is not limited to this configuration. That is, the processing device may be modified as long as it has any one of the following configurations (a) to (c).
(a) The processing device includes one or more processors that execute various processes in accordance with a computer program. Each processor includes a CPU and a memory, such as a RAM and a ROM. The memory stores program code or instructions configured to cause the CPU to execute processes, for example, an information providing process. The memory, which is a non-transitory computer-readable storage medium, includes any type of media that are accessible by general-purpose computers and dedicated computers.
(b) The processing device includes one or more dedicated hardware circuits that execute various processes. Examples of the dedicated hardware circuits include an application specific integrated circuit (ASIC) and a field programmable gate array (FPGA).
(c) The processing device includes a processor that executes part of various processes according to programs and a dedicated hardware circuit that executes the remaining processes.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A data management device for a vehicle, the data management device comprising processing circuitry configured to perform:
acquiring malfunction analysis data sets for analyzing a malfunction in the vehicle when the malfunction has been detected;
storing newly acquired ones of the malfunction analysis data sets in a first storage area until a total amount of the stored malfunction analysis data sets reaches a prescribed amount; and
when the newly acquired ones of the malfunction analysis data sets meet a predetermined specific condition, storing the newly acquired ones of the malfunction analysis data sets in a second storage area using a ring buffer method.

2. The data management device for the vehicle according to claim 1, wherein
types of malfunction are categorized into multiple types in advance, the types of the malfunction include a specific malfunction type, and
the specific condition includes a requirement that the malfunction analysis data sets correspond to the specific malfunction type.

3. The data management device for the vehicle according to claim 2, wherein
the vehicle includes multiple systems, the multiple systems including a specific system, and
the specific condition includes a requirement that the malfunction analysis data sets correspond to the specific system and the specific malfunction type.

4. The data management device for the vehicle according to claim 1, wherein the malfunction analysis data sets include a data set indicating a traveling state of the vehicle.

5. The data management device for the vehicle according to claim 4, wherein the malfunction analysis data sets include a data set indicating a total travel distance of the vehicle as the data set indicating the traveling state.

6. A vehicle, comprising:
the data management device according to claim 1; and
a storage device that stores the malfunction analysis data sets for analyzing a malfunction in the vehicle, wherein
the storage device includes the first storage area and the second storage area.

7. The vehicle according to claim 6, wherein the second storage area is non-volatile.

8. An analysis system, comprising:
the data management device according to claim 1 mounted on a vehicle;
a storage device mounted on the vehicle, the storage device storing the malfunction analysis data sets for analyzing a malfunction in the vehicle; and
a terminal device located outside the vehicle, the terminal device being capable of communicating with the data management device, wherein
the storage device includes the first storage area and the second storage area,
the processing circuitry being configured to perform:
transmitting the malfunction analysis data sets stored in the first storage area to the terminal device in response to an acquisition request signal from the terminal device.

9. The analysis system according to claim 8, wherein the data management device is configured to delete only the malfunction analysis data sets stored in the first storage area in response to a deletion request signal from the terminal device.

10. A non-transitory computer-readable storage medium that stores a data management program for causing processing circuitry to execute a data management process for a vehicle, wherein
the processing circuitry is mounted on the vehicle,
the data management process includes:
acquiring malfunction analysis data sets for analyzing a malfunction in the vehicle when the malfunction has been detected;
storing newly acquired ones of the malfunction analysis data sets in a first storage area until a total amount of the stored malfunction analysis data sets reaches a prescribed amount; and
when the newly acquired ones of the malfunction analysis data sets meet a predetermined specific condition, storing the newly acquired ones of the malfunction analysis data sets in a second storage area using a ring buffer method.

11. A data management method for a vehicle being executed by processing circuitry mounted on the vehicle, the method comprising:
acquiring malfunction analysis data sets for analyzing a malfunction in the vehicle when the malfunction has been detected;
storing newly acquired ones of the malfunction analysis data sets in a first storage area until a total amount of the stored malfunction analysis data sets reaches a prescribed amount; and
when the newly acquired ones of the malfunction analysis data sets meet a predetermined specific condition, storing the newly acquired ones of the malfunction analysis data sets in a second storage area using a ring buffer method.
